(19) United States
(12) Patent Application Publication
(10) Pub. No.: US 2012/0086288 A1
(43) Pub. Date: Apr. 12, 2012

(54) ELECTRIC ROTATING MACHINE

(75) Inventors: Asuka TANAKA, Kariya-shi (JP); Shin Kusase, Obu-shi (JP); Makoto Taniguchi, Obu-shi (JP)

(73) Assignee: DENSO CORPORATION, Kariya-city (JP)

(21) Appl. No.: 13/268,076

(22) Filed: Oct. 7, 2011

(30) Foreign Application Priority Data
Oct. 8, 2010 (JP) 2010-228316
May 6, 2011 (JP) 2011-103629

(51) Int. Cl. H02K 1/24

(52) U.S. Cl. 310/46

(57) ABSTRACT

An electric rotating machine includes a stator, a rotor, and a plurality of magnetic shields. The stator includes a stator core and a stator coil wound on the stator core. The stator core has a plurality of stator teeth arranged in the circumferential direction of the stator core. The rotor includes a rotor core that has a plurality of magnetic salient poles formed therein. The magnetic salient poles face the stator teeth through an air gap formed therebetween. Each of the magnetic shields is provided, either on the forward side of a corresponding one of the stator teeth or on the backward side of a corresponding one of the magnetic salient poles with respect to the rotational direction of the rotor, to create a magnetic flux which suppresses generation of a negative electromagnetic force that hinders rotation of the rotor.

### CROSS-REFERENCE TO RELATED APPLICATIONS

This application is based on and claims priority from Japanese Patent Applications No. 2010-228316 filed on Oct. 8, 2010 and No. 2011-103629 filed on May 6, 2011, the contents of which are hereby incorporated by reference in their entireties into this application.

### BACKGROUND OF THE INVENTION

1. Technical Field of the Invention

The present invention relates to electric rotating machines that are used in, for example, motor vehicles as electric motors and electric generators. In addition, the invention can also be applied to industrial machines and household electrical appliances.

2. Description of the Related Art

FIG. 20 shows a conventional electric rotating machine 100 (see, for example, Japanese Patent Application Publication No. 2001-268868). The electric rotating machine 100 includes a stator 104 and a rotor 105. The stator 104 includes a stator core 102 and a stator coil 103 wound on the stator core 102. The stator core 102 has a plurality of stator teeth 101 arranged in the circumferential direction of the stator core 102 at predetermined intervals. Further, each of the stator teeth 101 has a plurality of (e.g., four in FIG. 20) stator toothlets (or small teeth) 108 formed at the distal end thereof. The rotor 105 is rotatably disposed radially inside of the stator 104. The rotor 105 has a plurality of rotor toothlets 110 that are formed on the radially outer periphery of the rotor 105 so as to face the stator toothlets 108 through an air gap 109 formed therebetween. The rotor 105 is rotated by a positive electromagnetic force generated between the stator toothlets 108 and the rotor toothlets 110. Hereinafter, the positive electromagnetic force denotes an electromagnetic force which has a contribution to the torque of the electric rotating machine 100.

Moreover, in terms of increasing the torque of the electric rotating machine 100, it is preferable to set the circumferential pitches of the stator toothlets 108 and the rotor toothlets 110 small, in other words, to set the numbers of the stator toothlets 108 and the rotor toothlets 110 large.

However; if the circumferential pitches of the stator toothlets 108 and the rotor toothlets 110 are set too small, there will be also generated a negative electromagnetic force between the stator toothlets 108 and the rotor toothlets 110. The negative electromagnetic force hinders rotation of the rotor 105, thereby decreasing the torque of the electric rotating machine 100.

Therefore, it is desired to suppress generation of the negative electromagnetic force between the stator toothlets 108 and the rotor toothlets 110, thereby increasing the torque of the electric rotating machine 100.

In addition, electric rotating machines which generate reluctance torque, such as a reluctance synchronous motor, generally involve the problem of torque reduction due to a negative electromagnetic force generated between a stator and a rotor thereof.

### SUMMARY OF THE INVENTION

According to an embodiment, there is provided a first electric rotating machine which includes a stator, a rotor, and a plurality of magnetic shields. The stator includes a stator core and a stator coil wound on the stator core. The stator core has a plurality of stator teeth arranged in the circumferential direction of the stator core. The rotor includes a rotor core that has a plurality of magnetic salient poles formed therein. The magnetic salient poles face the stator teeth through an air gap formed therebetween. Each of the magnetic shields is provided, either on the forward side of a corresponding one of the stator teeth or on the backward side of a corresponding one of the magnetic salient poles with respect to the rotational direction of the rotor, to create a magnetic flux which suppresses generation of a negative electromagnetic force that hinders rotation of the rotor.

Consequently, with the magnetic shields, it is possible to suppress generation of the negative electromagnetic force generated between the stator teeth and the magnetic salient poles, thereby increasing the torque of the first electric rotating machine.

According to another embodiment, there is provided a second electric rotating machine which includes a stator and a rotor. The stator includes a stator core and a stator coil wound on the stator core. The stator core has a plurality of stator teeth arranged in the circumferential direction of the stator core. Each of the stator teeth has a plurality of stator toothlets formed at the distal end thereof. The rotor includes a rotor core that has a plurality of rotor toothlets formed therein. The rotor toothlets face the stator toothlets through an air gap formed therebetween. Further, for each of the stator teeth, there are provided, at the stator toothlets of the stator tooth, a plurality of magnetic shields to create a magnetic flux which suppresses generation of a negative electromagnetic force that hinders rotation of the rotor.

Consequently, with the magnetic shields, it is possible to suppress generation of the negative electromagnetic force generated between the stator toothlets and the rotor toothlets. As a result, it is possible to increase the torque of the second electric rotating machine. In addition, it also becomes possible to further increase the torque of the second electric rotating machine by increasing the numbers of the stator toothlets and the rotor toothlets.

According to further implementations, in the first and second electric rotating machines, each of the magnetic shields is made of an electric conductor. Consequently, it is possible to induce eddy current or short-circuit current in each of the magnetic shields, thereby creating the magnetic flux which suppresses generation of the negative electromagnetic force.

Further, in the first electric rotating machine, the magnetic shields are electrically insulated from the stator core and the rotor core. Consequently, the eddy current or short-circuit current induced in the magnetic shields is prevented from flowing to the stator core and the rotor core. As a result, it is possible to reliably suppress generation of the negative electromagnetic force without influencing generation of the positive electromagnetic force.

Similarly, in the second electric rotating machine, the magnetic shields are electrically insulated from the stator toothlets. Consequently, the eddy current or short-circuit current induced in the magnetic shields is prevented from flowing to the stator toothlets. As a result, it is possible to reliably suppress generation of the negative electromagnetic force without influencing generation of the positive electromagnetic force.

Furthermore, in the first and second electric rotating machines, each of the magnetic shields is made of copper or aluminum, both of which have a low resistivity. Consequently, eddy current or short-circuit current can be easily induced in the magnetic shields, thereby more effectively suppressing generation of the negative electromagnetic force.

In the first and second electric rotating machines, each of the magnetic shields may be made up of an electric conductor plate. In this case, it is possible to induce eddy current at the surface of each of the magnetic shields, thereby creating the magnetic flux which suppresses generation of the negative electromagnetic force.

Alternatively, each of the magnetic shields may be made up of a short-circuited coil. In this case, it is possible to induce short-circuit current in each of the magnetic shields, thereby creating the magnetic flux which suppresses generation of the negative electromagnetic force.

In the first electric rotating machine, each of the magnetic salient poles of the rotor core may be made up of a protrusion that protrudes toward the stator.

Alternatively, in the first electric rotating machine, the rotor core may be comprised of a plurality of substantially U-shaped rotor core segments that are arranged in the circumferential direction of the rotor core at predetermined intervals. Each of the rotor core segments may have a pair of protruding portions, which are respectively formed at opposite circumferential ends of the rotor core segment so as to protrude toward the stator, and a connecting portion that extends in the circumferential direction of the rotor core to connect the protruding portions. Each of the magnetic salient poles of the rotor core may be made up of a corresponding circumferentially-adjacent pair of the protruding portions of different ones of the rotor core segments.

As another alternative, in the first electric rotating machine, the rotor core may have a plurality of high magnetic reluctance portions and a plurality of low magnetic reluctance portions. The high magnetic reluctance portions are spaced from one another in the circumferential direction of the rotor core. Each of the low magnetic reluctance portions has a lower magnetic reluctance than the high magnetic reluctance portions and is formed between a corresponding circumferentially-adjacent pair of the high magnetic reluctance portions. Each of the magnetic salient poles of the rotor core may be made up of a corresponding one of the low magnetic reluctance portions.

In the first electric rotating machine, each of the stator teeth may have a plurality of stator toothlets formed at the distal end thereof. The rotor core may have a plurality of rotor toothlets each of which makes up one of the magnetic salient poles. Each of the magnetic shields may be provided either on a forward side of a corresponding one of the stator toothlets or on a backward side of a corresponding one of the rotor toothlets with respect to the rotational direction of the rotor.

Preferably, in the second electric rotating machine, each of the rotor toothlets is shaped so as to be asymmetric with respect to an imaginary line; the imaginary line is defined to extend straight through both the circumferential center of the rotor toothlet at a proximal end of the rotor toothlet and the radial center of a rotating shaft of the rotor. For each of the rotor toothlets, the air gap is wider on the backward side than on the forward side of the rotor toothlet with respect to the rotational direction of the rotor.

With the above configuration, it is possible to lower, for each of the rotor toothlets, the magnetic permeability between the rotor toothlet and the stator toothlets on the backward side of the rotor toothlet, thereby further reducing the negative magnetic force.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is an axial end view of both a stator and a rotor of an electric rotating machine according to a first embodiment of the invention;

FIG. 2 is an enlarged axial end view of part of the electric rotating machine;

FIG. 3A is a schematic view illustrating the distribution of electromagnetic force around one of the magnetic salient poles and the stator teeth radially facing the magnetic salient pole in the electric rotating machine when there is no magnetic shield provided for the magnetic salient pole;

FIG. 3B is a schematic view illustrating the distribution of electromagnetic force around one of the magnetic salient poles and the stator teeth radially facing the magnetic salient pole in the electric rotating machine when there is a magnetic shield provided for the magnetic salient pole;

FIG. 4 is a waveform chart giving a comparison of the torques of the electric rotating machine generated with and without the magnetic shields provided for the magnetic salient poles;

FIG. 5 is an enlarged axial end view of part of an electric rotating machine according to a second embodiment of the invention;

FIG. 6 is an axial end view of both a stator and a rotor of an electric rotating machine according to a third embodiment of the invention;

FIG. 7 is an enlarged axial end view of part of the electric rotating machine according to the third embodiment;

FIG. 8A is a schematic view illustrating the distribution of electromagnetic force around one of the magnetic salient poles and the stator teeth radially facing the magnetic salient pole in the electric rotating machine according to the third embodiment when there is no magnetic shield provided for the magnetic salient pole;

FIG. 8B is a schematic view illustrating the distribution of electromagnetic force around one of the magnetic salient poles and the stator teeth radially facing the magnetic salient pole in the electric rotating machine according to the third embodiment when there is a magnetic shield provided for the magnetic salient pole;

FIG. 9 is an enlarged axial end view of part of an electric rotating machine according to a fourth embodiment of the invention;

FIG. 10A is an enlarged axial end view of part of an electric rotating machine according to a fifth embodiment of the invention;

FIG. 10B is an enlarged axial end view of part of an electric rotating machine according to a sixth embodiment of the invention;

FIG. 11 is an axial end view of both a stator and a rotor of an electric rotating machine according to a seventh embodiment of the invention;

FIG. 12 is an enlarged view of that part of FIG. 11 which is enclosed with a dashed line;

FIG. 13A is a schematic view illustrating the distribution of electromagnetic force around stator toothlets and rotor toothlets in the electric rotating machine according to the seventh embodiment when there are no magnetic shields provided for the stator toothlets;

FIG. 13B is a schematic view illustrating the distribution of electromagnetic force around the stator toothlets and the rotor toothlets in the electric rotating machine according to the seventh embodiment when there are magnetic shields provided for the stator toothlets;

FIG. 14 is a waveform chart giving a comparison of the torques of the electric rotating machine according to the seventh embodiment generated with and without the magnetic shields provided for the stator toothlets;

FIG. 15 is an enlarged axial end view of part of an electric rotating machine according to an eighth embodiment of the invention;

FIG. 16 is an enlarged axial end view of part of an electric rotating machine according to a ninth embodiment of the invention;

FIG. 17 is an enlarged axial end view of part of an electric rotating machine according to a tenth embodiment of the invention;

FIG. 18 is an axial end view of both a stator and a rotor of an electric rotating machine according to an eleventh embodiment of the invention;

FIG. 19 is an enlarged view of that part of FIG. 18 which is enclosed with a dashed line; and

FIG. 20 is a schematic view illustrating both positive and negative electromagnetic forces generated between stator toothlets and rotor toothlets in a conventional electric rotating machine.

### DESCRIPTION OF PREFERRED EMBODIMENTS

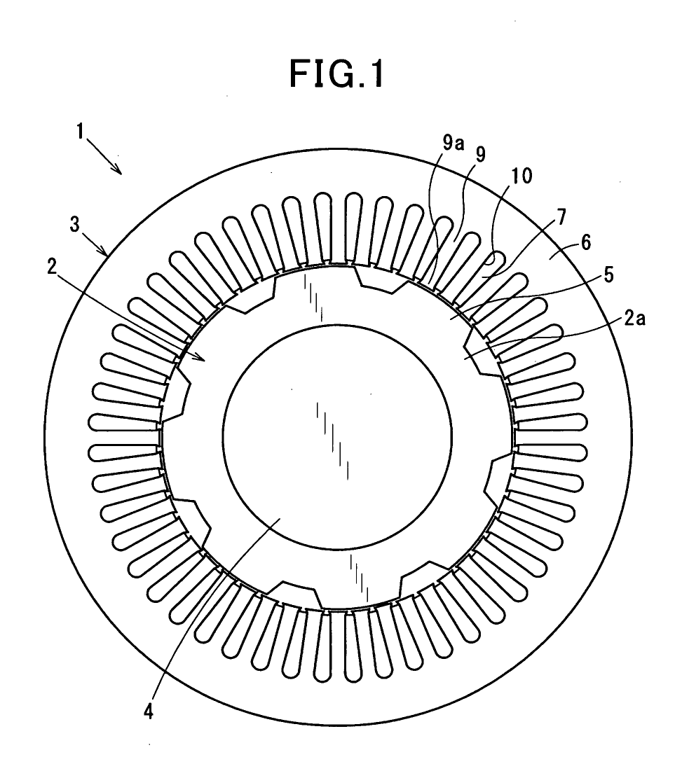

Preferred embodiments of the present invention will be described hereinafter with reference to FIGS. 1-19. It should be noted that for the sake of clarity and understanding, identical components having identical functions in different embodiments of the invention have been marked, where possible, with the same reference numerals in each of the figures and that for the sake of avoiding redundancy, descriptions of the identical components will not be repeated.

### First Embodiment

FIG. 1 shows the overall configuration of an electric rotating machine 1 according to a first embodiment of the invention. In this embodiment, the electric rotating machine 1 is configured as a reluctance synchronous motor.

As shown in FIG. 1, the electric rotating machine 1 includes a rotor 2 and a stator 3 that is disposed radially outside of the rotor 2 so as to surround the rotor 2.

Specifically, the rotor 2 includes a rotor core 2a that is formed, by laminating a plurality of magnetic steel sheets, into a hollow cylindrical shape. The rotor core 2a is fixed, at the radial center thereof, to a rotating shaft 4. On the radially outer periphery of the rotor core 2a, there are formed a plurality of (e.g., eight in the present embodiment) magnetic salient poles 5 for generating reluctance torque. The magnetic salient poles 5 each protrude radially outward (i.e., toward the stator 3) and are arranged in the circumferential direction of the rotor core 2a at predetermined intervals.

The stator 3 includes a stator core 6 and a multi-phase stator coil 7. The stator core 6 is formed, by laminating a plurality of magnetic steel sheets, into a hollow cylindrical shape. The stator coil 7 is comprised of a plurality of phase windings and wound on the stator core 6 using a distributed winding method.

The stator core 6 has a plurality of stator teeth 9 that are formed on the radially inner periphery of the stator core 6 so as to protrude radially inward (i.e., toward the rotor 2). The stator teeth 9 are arranged in the circumferential direction of the stator core 6 at predetermined intervals. Further, between each circumferentially-adjacent pair of the stator teeth 9, there is formed a slot 10. The stator coil 7 is wound around the stator teeth 9 so as to be received in the slots 10 of the stator core 6. In addition, in the present embodiment, the number of the stator teeth 9 is equal to 48 and the stator coil 7 is a three-phase stator coil.

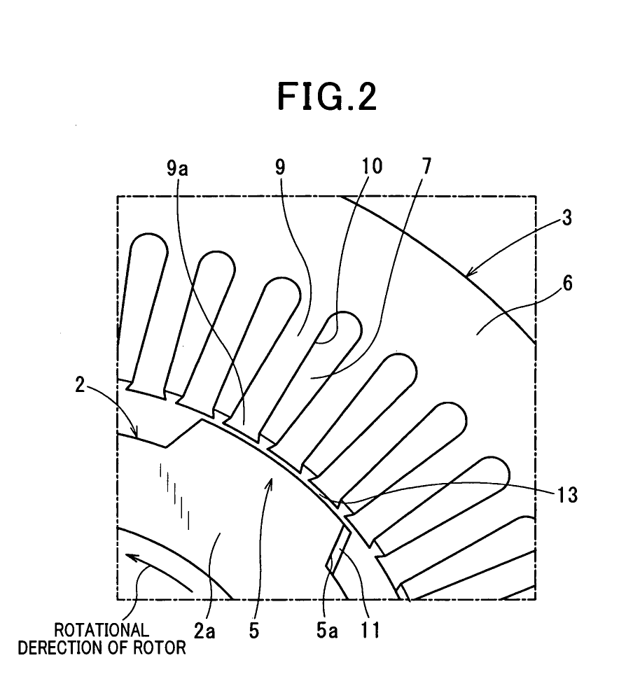

Referring further to FIG. 2, in the present embodiment, each of the stator teeth 9 has a distal end portion (i.e., a radially inner end portion facing the rotor 2) 9a which protrudes radially inward from a radially inner end of the stator coil 7 and in which the circumferential width of the stator tooth 9 increases in the radially inward direction.

The stator teeth 9 radially face the magnetic salient poles 5 of the rotor core 2a through an air gap 13 formed therebetween. In operation, upon energization of the stator coil 7, a positive electromagnetic force is generated between the stator teeth 9 and the magnetic salient poles 5, thereby causing the rotor 2 to rotate.

Furthermore, in the present embodiment, for each of the magnetic salient poles 5, there is provided a magnetic shield 11 on the backward side of the magnetic salient pole 5 with respect to the rotational direction of the rotor 2. The magnetic shield 11 generates a magnetic flux to suppress generation of a negative electromagnetic force between the magnetic salient pole 5 and the stator teeth 9; the negative electromagnetic force hinders rotation of the rotor 2.

More specifically, in the present embodiment, the magnetic shield 11 is implemented by an electric conductor plate that is made of for example, aluminum or copper. The magnetic shield 11 is fixed to a backward end surface 5a of the magnetic salient pole 5. Further, between the magnetic shield 11 and the backward end surface 5a of the magnetic salient pole 5, there is interposed an insulating plate or insulating coat (not shown) to electrically insulate the magnetic shield 11 from the magnetic salient pole 5.

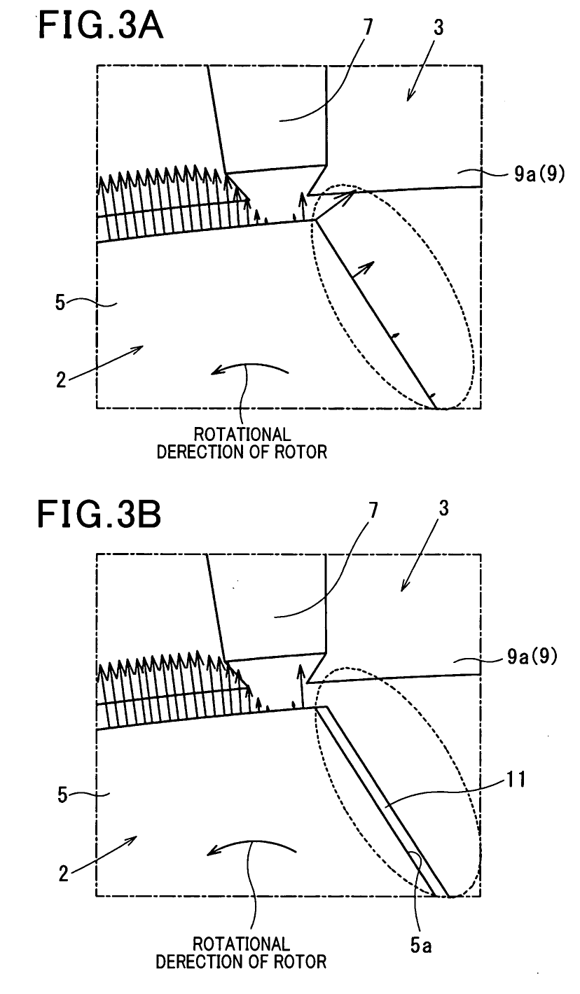

The advantageous effects of providing the magnetic shields 11 in the electric rotating machine 1 will be described hereinafter with reference to FIGS. 3A and 3B.

FIG. 3A illustrates the distribution of electromagnetic force around one of the magnetic salient poles 5 and the stator teeth 9 radially facing the magnetic salient pole 5 when there is no magnetic shield 11 provided for the magnetic salient pole 5. On the other hand, FIG. 3B illustrates the distribution of electromagnetic force around one of the magnetic salient poles 5 and the stator teeth 9 radially facing the magnetic salient pole 5 when there is the magnetic shield 11 provided for the magnetic salient pole 5 according to the present embodiment.

As shown in FIG. 3A, when there is no magnetic shield 11 provided for the magnetic salient pole 5, a negative electromagnetic force is generated between the magnetic salient pole 5 and the distal end portions 9a of the stator teeth 9 (see that part of FIG. 3A which is enclosed with a dashed line).

In comparison, as shown in FIG. 3B, when there is the magnetic shield 11 provided for the magnetic salient pole 5, generation of the negative electromagnetic force is suppressed (see that part of FIG. 3B which is enclosed with a dashed line).

This is because: the magnetic field, which is created upon energization of the stator coil 7, induces eddy current at the surface of the magnetic shield 11; the eddy current creates a magnetic flux which weakens the magnetic flux that generates the negative electromagnetic force.

More specifically, the eddy current induced at the surface of the magnetic shield 11 creates the magnetic flux in a direction to hinder the magnetic flux created by the energization of the stator coil 7 (i.e., the main magnetic flux). Consequently, the magnetic flux density around the magnetic shield 11 is lowered, thereby lowering the negative electromagnetic force. As a result, the torque of the electric rotating machine 1 is increased.

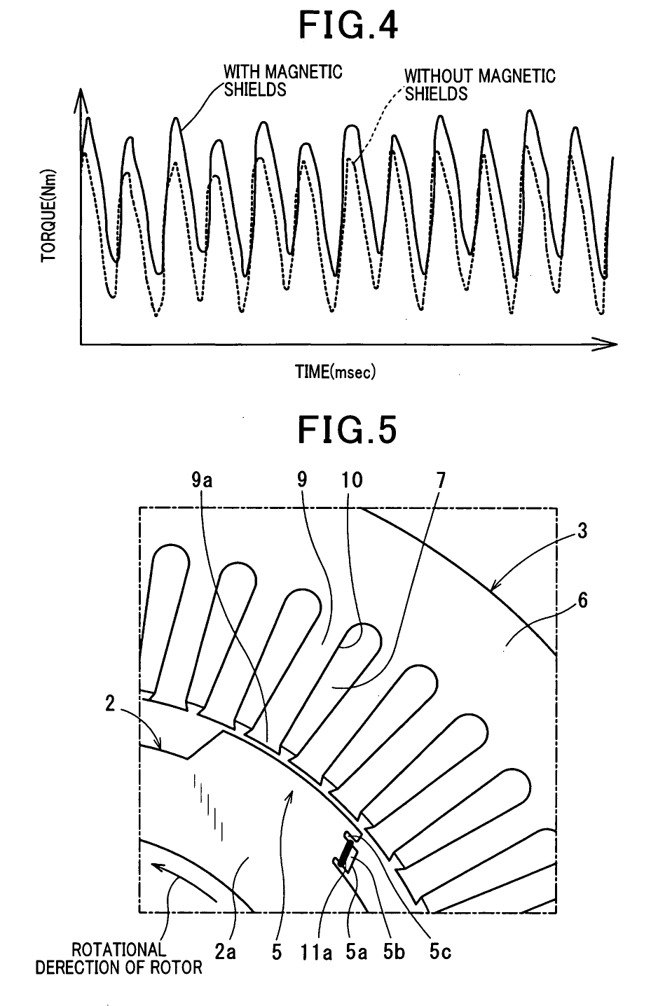

FIG. 4 gives a comparison of the torques of the electric rotating machine 1 generated with and without the magnetic shields 11 provided for the magnetic salient poles 5; the torques are obtained by a numerical analysis.

As seen from FIG. 4, the torque of the electric rotating machine 1 generated with the magnetic shields 11 provided for the magnetic salient poles 5 is higher than that generated without the magnetic shields 11. More specifically, in the present embodiment, the torque generated with the magnetic shields 11 provided for the magnetic salient poles 5 is higher than that generated without the magnetic shields 11 by about 10% on average.

### Second Embodiment

This embodiment illustrates an electric rotating machine 1 which has almost the same configuration as the electric rotating machine 1 according to the first embodiment; therefore, only the differences therebetween will be described hereinafter.

Referring to FIG. 5, in this embodiment, the electric rotating machine 1 includes, instead of the magnetic shields 11 in the first embodiment, a plurality of magnetic shields 11a each of which is made up of a short-circuited coil.

More specifically, the short-circuited coil is a coil that is short-circuited to form a closed electric circuit. The short-circuited coil is obtained by winding a coated electric wire which includes an electric conductor wire made of, for example, copper or aluminum and an insulating coat that covers the surface of the electric conductor wire.

Moreover, in the present embodiment, for each of the magnetic salient poles 5 of the rotor core 2a, there are formed, at the backward end surface 5a of the magnetic salient pole 5, a protrusion 5b and a groove 5c that surrounds the protrusion 5b.

Each of the magnetic shields 11a is wound around the protrusion 5b of a corresponding one of the magnetic salient poles 5 so as to be received in the groove 5c of the corresponding magnetic salient pole 5. In addition, since each of the magnetic shields 11a is made of the coated electric wire as described above, it is electrically insulated from the corresponding magnetic salient pole 5.

In operation of the electric rotating machine 1, for each of the magnetic shields 11a, the magnetic field, which is created upon energization of the stator coil 7, induces short-circuit current in the magnetic shield 11a; the short-circuit current creates a magnetic flux which weakens the magnetic flux that generates the negative electromagnetic force.

More specifically, the short-circuit current creates the magnetic flux the phase of which lags behind the phase of the magnetic flux created by the energization of the stator coil 7 (i.e., the main magnetic flux). Consequently, the magnetic flux density around the magnetic shield 11a is lowered, thereby lowering the negative electromagnetic force. As a result, the torque of the electric rotating machine 1 is increased.

### Third Embodiment

This embodiment illustrates an electric rotating machine 1 which has almost the same configuration as the electric rotating machine 1 according to the first embodiment; therefore, only the differences therebetween will be described hereinafter.

In the first embodiment, the rotor core 2a has a one-piece structure as shown in FIG. 1.

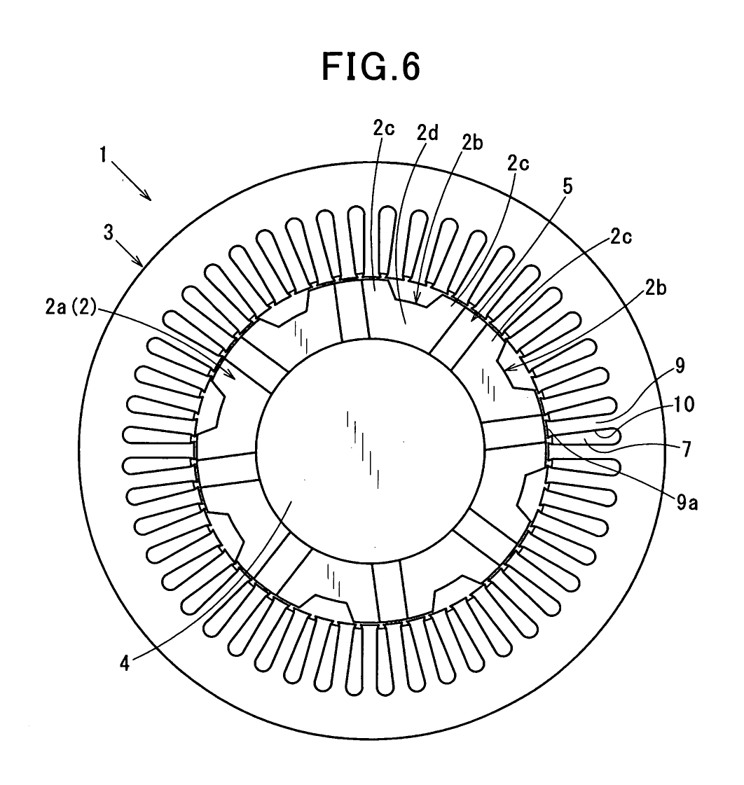

In comparison, in the present embodiment, as shown in FIG. 6, the rotor core 2a is comprised of a plurality of rotor core segments 2b that are arranged in the circumferential direction of the rotor core 2a at predetermined intervals.

Each of the rotor core segments 2b has a substantially U-shape. More specifically, each of the rotor core segments 2b has a pair of protruding portions 2c, which are respectively formed at opposite circumferential ends of the rotor core segment 2b so as to protrude radially outward (i.e., toward the stator 3), and a connecting portion 2d that extends in the circumferential direction of the rotor core 2a to connect radially inner parts of the protruding portions 2c.

The rotor core segments 2b are fixed on the rotating shaft 4 with predetermined circumferential gaps formed therebetween. Consequently, each circumferentially-adjacent pair of the protruding portions 2c of different ones of the rotor core segments 2b makes up one magnetic salient pole 5 of the rotor core 2a. In addition, in the present embodiment, both the number of the rotor core segments 2b and the number of the magnetic salient poles 5 of the rotor core 2a is equal to 8.

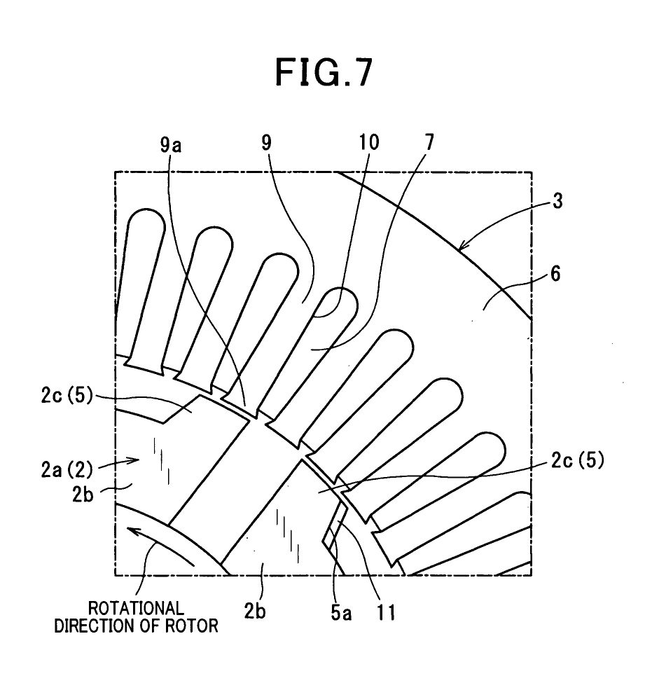

Moreover, as shown in FIG. 7, for each of the magnetic salient poles 5, there is provided a magnetic shield 11 on the backward side of the magnetic salient pole 5 with respect to the rotational direction of the rotor 2. The magnetic shield 11 generates a magnetic flux to suppress generation of a negative electromagnetic force between the magnetic salient pole 5 and the stator teeth 9; the negative electromagnetic force hinders rotation of the rotor 2.

More specifically, in the present embodiment, the magnetic shield 11 is implemented by an electric conductor plate as in the first embodiment. The magnetic shield 11 is fixed to a backward end surface 5a of the magnetic salient pole 5. Here, the backward end surface 5a of the magnetic salient pole 5 is represented by a backward end surface of the forward-side protruding portion 2c of the backward-side one of the two circumferentially-adjacent rotor core segments 2b which together make up the magnetic salient pole 5. Further, between the magnetic shield 11 and the backward end surface 5a of the magnetic salient pole 5, there is interposed an insulating plate or insulating coat (not shown) to electrically insulate the magnetic shield 11 from the magnetic salient pole 5.

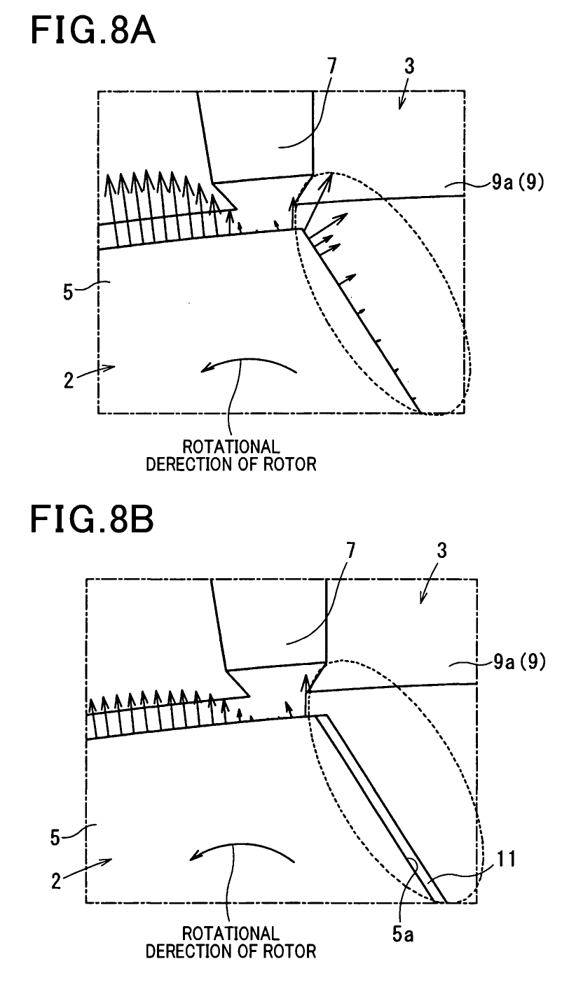

FIG. 8A illustrates the distribution of electromagnetic force around one of the magnetic salient poles 5 and the stator teeth 9 radially facing the magnetic salient pole 5 when there is no magnetic shield 11 provided for the magnetic salient pole 5. On the other hand, FIG. 8B illustrates the distribution of electromagnetic force around one of the magnetic salient poles 5 and the stator teeth 9 radially facing the magnetic salient pole 5 when there is the magnetic shield 11 provided for the magnetic salient pole 5 according to the present embodiment.

As shown in FIG. 8A, when there is no magnetic shield 11 provided for the magnetic salient pole 5, a negative electromagnetic force is generated between the magnetic salient pole 5 and the distal end portions 9a of the stator teeth 9 (see that part of FIG. 8A which is enclosed with a dashed line).

In comparison, as shown in FIG. 8B, when there is the magnetic shield 11 provided for the magnetic salient pole 5, generation of the negative electromagnetic force is suppressed (see that part of FIG. 8B which is enclosed with a dashed line).

In addition, in the present embodiment, the rotor core 2a has the segmented structure as described above. Therefore, it is easier for the negative electromagnetic force to be generated than in the first embodiment where the rotor core 2a has the one-piece structure. However, even in the present embodiment, it is still possible to reliably suppress generation of the negative electromagnetic force with the magnetic shields 11 provided for the magnetic salient poles 5.

### Fourth Embodiment

This embodiment illustrates an electric rotating machine 1 which has almost the same configuration as the electric rotating machine 1 according to the third embodiment; therefore, only the differences therebetween will be described hereinafter.

In the third embodiment, each of the magnetic shields 11 is provided on the backward side of a corresponding one of the magnetic salient poles 5 of the rotor core 2a with respect to the rotational direction of the rotor 2.

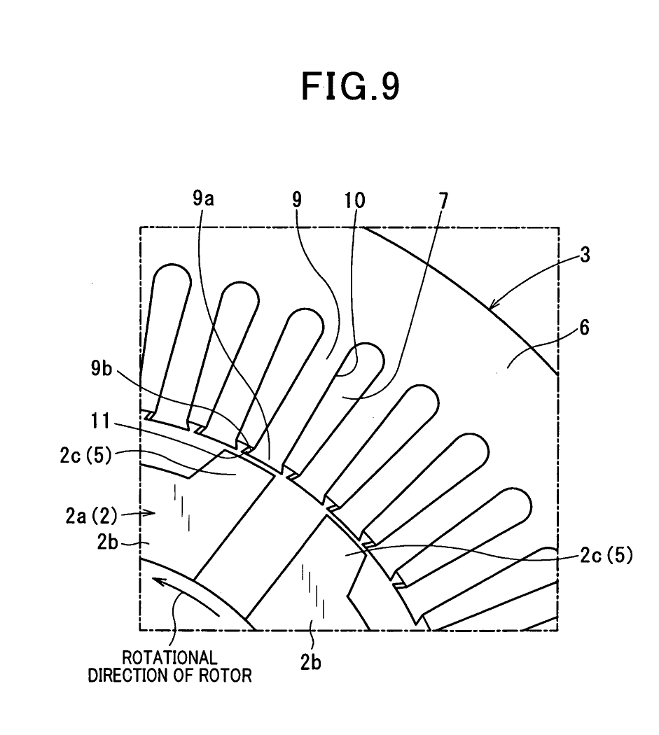

In comparison, in the present embodiment, as shown in FIG. 9, each of the magnetic shields 11 is provided on the forward side of the distal end portion 9a of a corresponding one of the stator teeth 9 with respect to the rotational direction of the rotor 2.

More specifically, in the present embodiment, each of the magnetic shields 11 is fixed to a forward end surface 9b of the distal end portion 9a of the corresponding stator tooth 9. Further, between the magnetic shield 11 and the forward end surface 9b of the distal end portion 9a of the corresponding stator tooth 9, there is interposed an insulating plate or insulating coat (not shown) to electrically insulate the magnetic shield 11 from the corresponding stator tooth 9.

By providing the magnetic shields 11 for the stator teeth 9, it is possible to achieve the same advantageous effects as providing the magnetic shields 11 for the magnetic salient poles 5 of the rotor core 2a.

### Fifth Embodiment

This embodiment illustrates an electric rotating machine 1 which has almost the same configuration as the electric rotating machine 1 according to the first embodiment; therefore, only the differences therebetween will be described hereinafter.

In the first embodiment, each of the magnetic salient poles 5 of the rotor core 2a is made up of a protrusion which is formed on the radially outer periphery of the rotor core 2a to protrude radially outward (i.e., toward the stator 3).

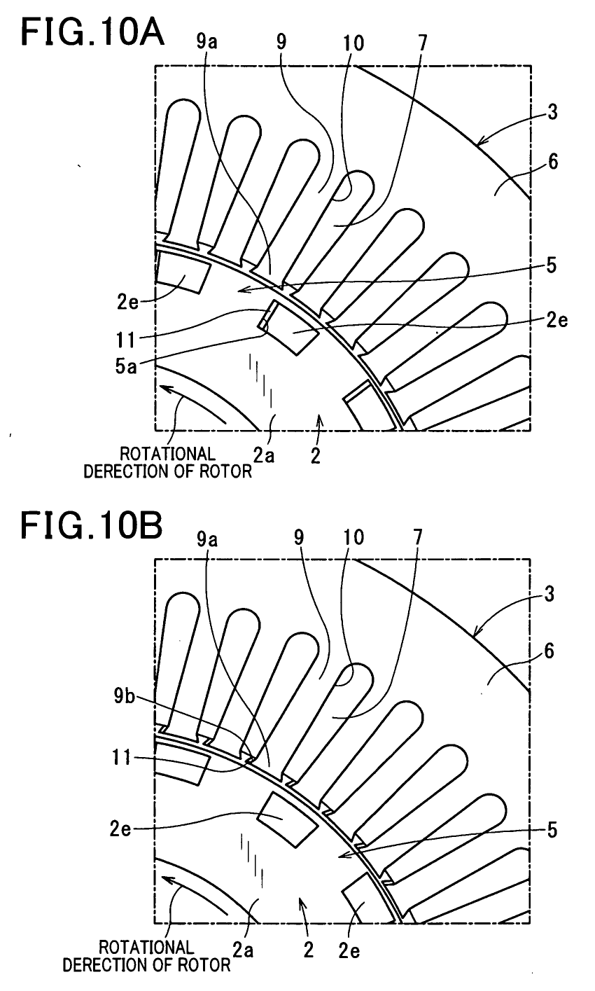

In comparison, in the present embodiment, as shown in FIG. 10A, the rotor core 2a has a plurality of voids (or empty spaces) 2e formed therein. The voids 2e are spaced from one another in the circumferential direction of the rotor core 2a at predetermined intervals. Each of the voids 2e, which has a high magnetic reluctance, makes up a magnetic flux-blocking portion of the rotor core 2a. Further, between each circumferentially-adjacent pair of the voids 2e, there is formed a low magnetic reluctance portion of the rotor core 2a; the low magnetic reluctance portion makes up a magnetic salient pole 5 of the rotor core 2a. Moreover, in the present embodiment, for each of the magnetic salient poles 5, there is provided a magnetic shield 11 on the backward side of the magnetic salient pole 5 with respect to the rotational direction of the rotor 2. The magnetic shield 11 generates a magnetic flux to suppress generation of a negative electromagnetic force between the magnetic salient pole 5 and the stator teeth 9; the negative electromagnetic force hinders rotation of the rotor 2.

More specifically, in the present embodiment, the magnetic shield 11 is implemented by an electric conductor plate as in the first embodiment. The magnetic shield 11 is fixed to a backward end surface 5a of the magnetic salient pole 5. Here, the backward end surface 5a of the magnetic salient pole 5 faces that one of the voids 2e which is on the backward side of the magnetic salient pole 5. Further, between the magnetic shield 11 and the backward end surface 5a of the magnetic salient pole 5, there is interposed an insulating plate or insulating coat (not shown) to electrically insulate the magnetic shield 11 from the magnetic salient pole 5.

The above-described electric rotating machine 1 according to the present embodiment has the same advantages as that according to the first embodiment.

### Sixth Embodiment

This embodiment illustrates an electric rotating machine 1 which has almost the same configuration as the electric rotating machine 1 according to the fifth embodiment; therefore, only the differences therebetween will be described hereinafter.

In the fifth embodiment, each of the magnetic shields 11 is provided on the backward side of a corresponding one of the magnetic salient poles 5 of the rotor core 2a with respect to the rotational direction of the rotor 2.

In comparison, in the present embodiment, as shown in FIG. 10B, each of the magnetic shields 11 is provided on the forward side of the distal end portion 9a of a corresponding one of the stator teeth 9 with respect to the rotational direction of the rotor 2.

More specifically, in the present embodiment, each of the magnetic shields 11 is fixed to a forward end surface 9b of the distal end portion 9a of the corresponding stator tooth 9. Further, between the magnetic shield 11 and the forward end surface 9b of the distal end portion 9a of the corresponding stator tooth 9, there is interposed an insulating plate or insulating coat (not shown) to electrically insulate the magnetic shield 11 from the corresponding stator tooth 9.

By providing the magnetic shields 11 for the stator teeth 9, it is possible to achieve the same advantageous effects as providing the magnetic shields 11 for the magnetic salient poles 5 of the rotor core 2a.

### Seventh Embodiment

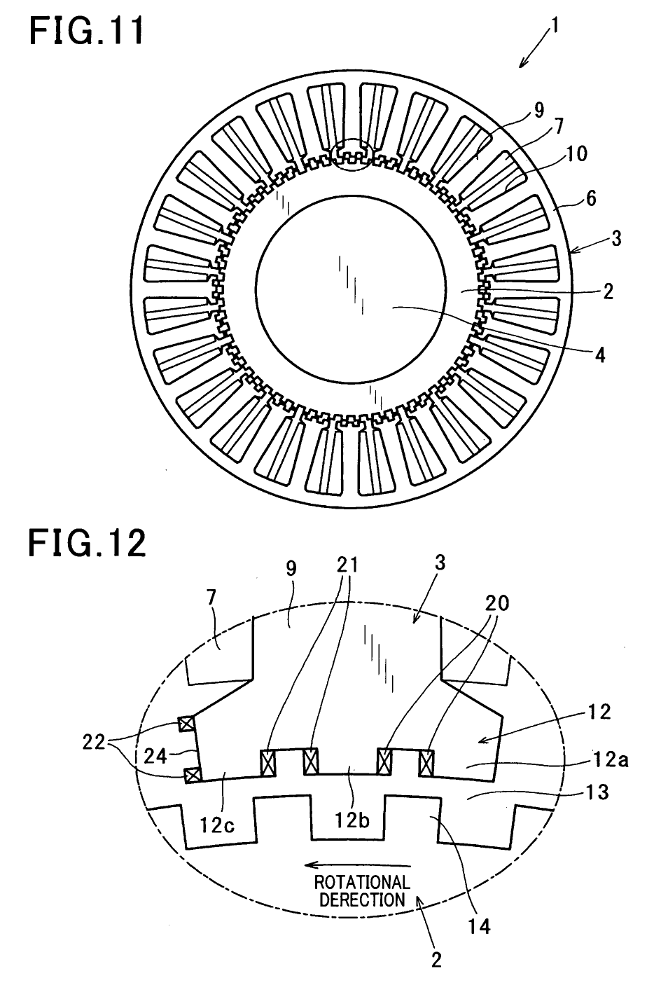

FIG. 11 shows the overall configuration of an electric rotating machine 1 according to a seventh embodiment of the invention. In this embodiment, the electric rotating machine 1 is configured as a reluctance stepping motor.

As shown in FIG. 11, the electric rotating machine 1 includes a rotor 2 and a stator 3 that is disposed radially outside of the rotor 2 so as to surround the rotor 2.

Specifically, the rotor 2 is formed, by laminating a plurality of magnetic steel sheets, into a hollow cylindrical shape. The rotor 2 is fixed, at the radial center thereof, to a rotating shaft 4. Further, as shown in FIG. 12, the rotor 2 has a plurality of rotor toothlets 14 that are formed on the radially outer periphery of the rotor 2 and arranged in the circumferential direction of the rotor 2 at predetermined intervals.

On the other hand, the stator 3 includes a stator core 6 and a multi-phase stator coil 7. The stator core 6 is formed, by laminating a plurality of magnetic steel sheets, into a hollow cylindrical shape. The stator coil 7 is comprised of a plurality of phase windings and wound on the stator core 6 using a concentrated winding method.

The stator core 6 has a plurality of stator teeth 9 that are formed on the radially inner periphery of the stator core 6 so as to protrude radially inward (i.e., toward the rotor 2). The stator teeth 9 are arranged in the circumferential direction of the stator core 6 at predetermined intervals. Further, between each circumferentially-adjacent pair of the stator teeth 9, there is formed a slot 10. The stator coil 7 is wound around the stator teeth 9 so as to be received in the slots 10 of the stator core 6.

Furthermore, as shown in FIG. 12, each of the stator teeth 9 has a plurality of stator toothlets 12 that are formed at the distal end (i.e., the radially inner end facing the rotor 2) of the stator tooth 9 so as to protrude radially inward (i.e., toward the rotor 2). The stator toothlets 12 are arranged in the circumferential direction of the stator core 6 at predetermined intervals. The stator toothlets 12 radially face the rotor toothlets 14 through an air gap 13 formed therebetween.

It should be noted that the number of the stator toothlets 12 for each of the stator teeth 9 and the number of the rotor toothlets 14 may be suitably set according to, for example, the number of the stator teeth 9 and the required output torque of the electric rotating machine 1.

In operation of the electric rotating machine 1, by sequentially switching the energizations of the phase windings of the stator coil 7 using pulse signals, a rotating magnetic field is created which causes the rotor 2 to rotate. More specifically, the rotating magnetic field generates a positive electromagnetic force between the stator toothlets 12 of the stator teeth 9 and the rotor toothlets 14, thereby causing the rotor 2 to rotate.

Furthermore, in the present embodiment, for each of the stator teeth 9, there are provided a plurality of magnetic shields at the stator toothlets 12 of the stator tooth 9. Each of the magnetic shields generates a magnetic flux to suppress generation of a negative electromagnetic force between the stator toothlets 12 and the rotor toothlets 14; the negative electromagnetic force hinders rotation of the rotor 2.

More specifically, as shown in FIG. 12, in the present embodiment, each of the stator teeth 9 includes three stator toothlets 12, i.e., a stator toothlet 12a located on the backward side (or on the upstream side with respect to the rotational direction of the rotor 2), a stator toothlet 12c located on the forward side (or on the downstream side with respect to the rotational direction of the rotor 2) and a stator toothlet 12b located between the stator toothlets 12a and 12c. The magnetic shields provided for the stator tooth 9 are implemented by three short-circuited coils 20-22. The short-circuited coil 20 is provided within a groove formed between the stator toothlets 12a and 12b. The short-circuited coil 21 is provided within a groove formed between the stator tootlets 12b and 12c. The short-circuited coil 22 is provided on a forward end surface 24 of the stator toothlet 12c.

In addition, each of the short-circuited coils 20-22 is a coil that is short-circuited to form a closed electric circuit. Moreover, each of the short-circuited coils 20-22 is obtained by winding a coated electric wire which includes an electric conductor wire made of, for example, copper or aluminum and an insulating coat that covers the surface of the electric conductor wire. Consequently, the short-circuited coils 20-22 are electrically insulated from the stator toothlets 12a-12c.

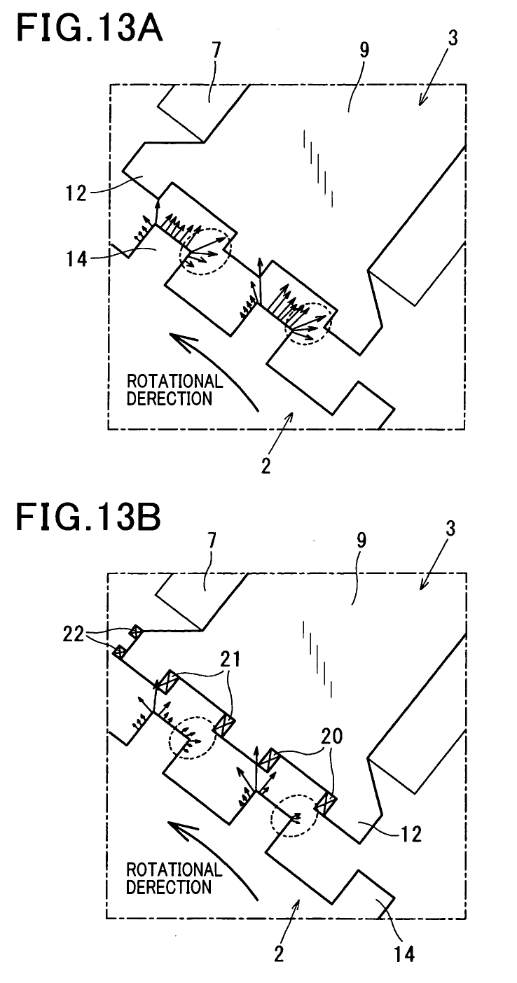

FIG. 13A illustrates the distribution of electromagnetic force around the stator toothlets 12 and the rotor toothlets 14 when there are no magnetic shields provided at the stator toothlets 12. On the other hand, FIG. 13B illustrates the distribution of electromagnetic force around the stator toothlets 12 and the rotor toothlets 14 when there are the magnetic shields (i.e., the short-circuited coils 20-22) provided at the stator toothlets 12.

As shown in FIG. 13A, when there are no magnetic shields provided at the stator toothlets 12, a negative electromagnetic force is generated between the stator toothlets 12 and the rotor toothlets 14 (see those parts of FIG. 13A which are enclosed with a dashed line).

In comparison, as shown in FIG. 13B, when there are the magnetic shields (i.e., the short-circuited coils 20-22) provided at the stator toothlets 12, generation of the negative electromagnetic force is suppressed (see those parts of FIG. 13B which are enclosed with a dashed line).

This is because: the magnetic field, which is created upon energization of the stator coil 7, induces short-circuit current in each of the short-circuited coils 20-22; the short-circuit current creates a magnetic flux which weakens the magnetic flux that generates the negative electromagnetic force.

More specifically, the short-circuit current creates the magnetic flux the phase of which lags behind the phase of the magnetic flux created by the energization of the stator coil 7 (i.e., the main magnetic flux). Consequently, the magnetic flux density around the short-circuited coils 20-22 is lowered, thereby lowering the negative electromagnetic force. As a result, the torque of the electric rotating machine 1 is increased.

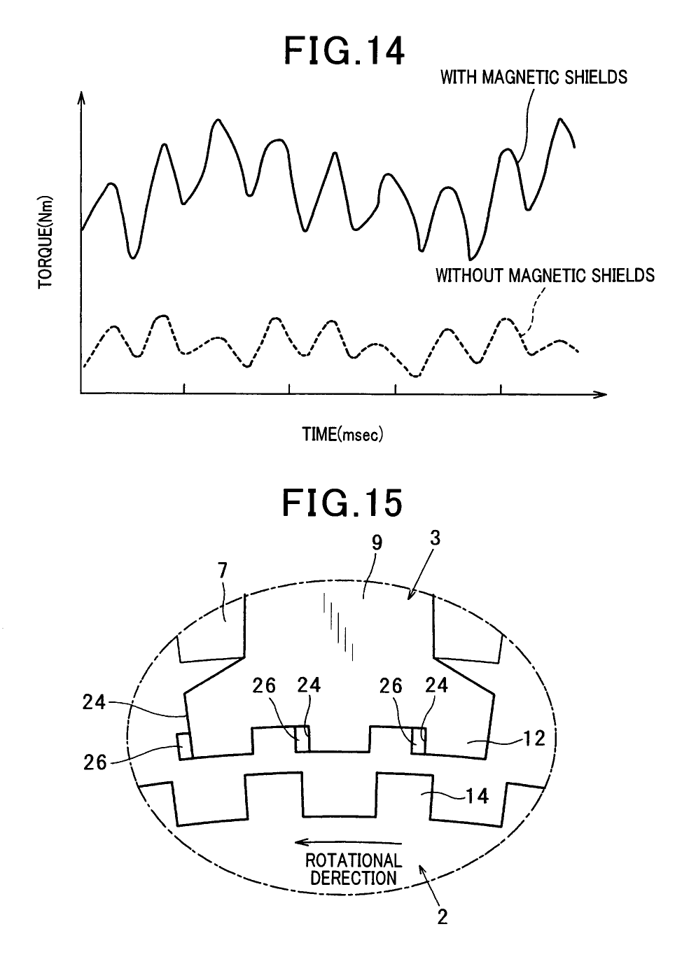

FIG. 14 gives a comparison of the torques of the electric rotating machine 1 generated with and without the magnetic shields provided at the stator toothlets 12; the torques are obtained by a numerical analysis.

As seen from FIG. 14, the torque of the electric rotating machine 1 generated with the magnetic shields provided at the stator toothlets 12 is much higher than that generated without the magnetic shields.

### Eighth Embodiment

This embodiment illustrates an electric rotating machine 1 which has almost the same configuration as the electric rotating machine 1 according to the seventh embodiment; therefore, only the differences therebetween will be described hereinafter.

As described previously, in the seventh embodiment, for each of the stator teeth 9, the magnetic shields are implemented by the short-circuited coils 20-22 provided at the stator toothlets 12 of the stator tooth 9.

In comparison, in the present embodiment, as shown in FIG. 15, for each of the stator teeth 9, the magnetic shields are implemented by a plurality of electric conductor plates 26 each of which is fixed to the forward end surface 24 of a corresponding one of the stator toothlets 12 of the stator tooth 9.

Further, for each of the electric conductor plates 26, there is an insulating plate or insulating coat (not shown) interposed between the electric conductor plate 26 and the forward end surface 24 of the corresponding stator toothlet 12. Consequently, the electric conductor plates 26 are electrically insulated from the corresponding stator toothlets 12.

In operation of the electric rotating machine 1, the magnetic field, which is created upon energization of the stator coil 7, induces eddy current at the surfaces of the electric conductor plates 26; the eddy current creates a magnetic flux which weakens the magnetic flux that generates the negative electromagnetic force.

More specifically, the eddy current creates the magnetic flux in a direction to hinder the magnetic flux created by the energization of the stator coil 7 (i.e., the main magnetic flux). Consequently, the magnetic flux density around the electric conductor plates 26 is lowered, thereby lowering the negative electromagnetic force. As a result, the torque of the electric rotating machine 1 is increased.

Furthermore, in the present embodiment, the electric conductor plates 26 are made of aluminum or copper, both of which have a low resistivity. Consequently, the eddy current can be easily generated at the surfaces of the electric conductor plates 26, thereby more effectively suppressing generation of the negative electromagnetic force.

In addition, the electric conductor plates 26 can be securely fixed to the forward end surfaces 24 of the corresponding stator toothlets 12 by: first temporarily fixing the electric conductor plates 26 to the forward end surfaces 24; and then molding together all the parts of the stator 3 including the stator coil 7.

### Ninth Embodiment

This embodiment illustrates an electric rotating machine 1 which has almost the same configuration as the electric rotating machine 1 according to the eighth embodiment; therefore, only the differences therebetween will be described hereinafter.

As described previously, in the eighth embodiment, for each of the stator teeth 9, the magnetic shields are implemented by the electric conductor plates 26 fixed to the forward end surfaces 24 of the corresponding stator toothlets 12 of the stator tooth 9.

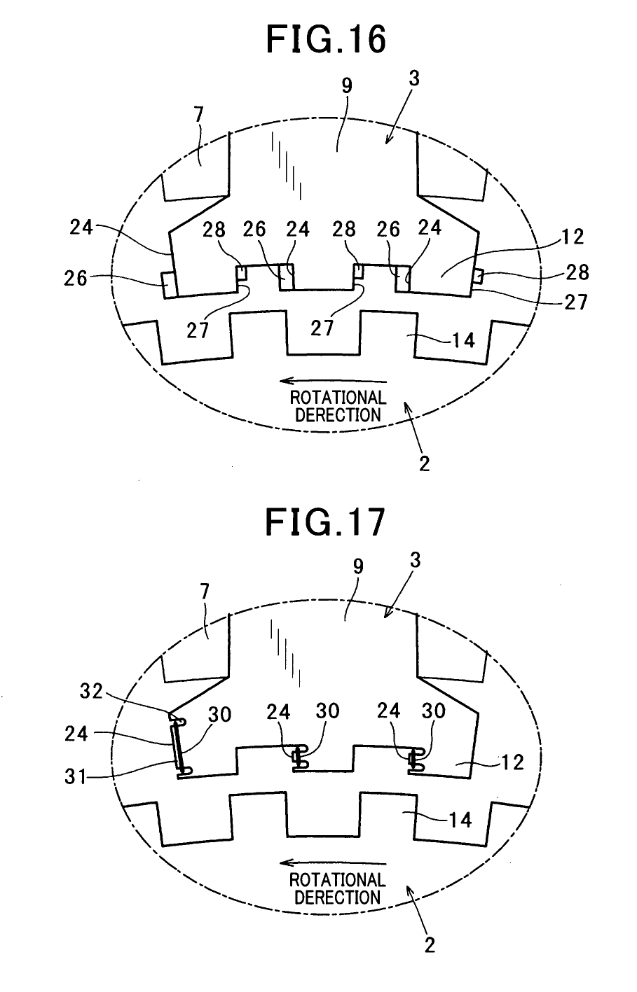

In comparison, in the present embodiment, as shown in FIG. 16, for each of the stator teeth 9, the magnetic shields are implemented by not only the electric conductor plates 26 but also a plurality of electric conductor plates 28. Each of the electric conductor plates 28 is fixed to the backward end surface 27 of a corresponding one of the stator toothlets 12 of the stator tooth 9.

Further, in the present embodiment, the radial width of the electric conductor plates 26 is set to be higher than that of the electric conductor plates 28. In addition, the larger the difference in radial width between the electric conductor plates 26 and the electric conductor plates 28, the more effectively generation of the negative electromagnetic force can be suppressed.

### Tenth Embodiment

This embodiment illustrates an electric rotating machine 1 which has almost the same configuration as the electric rotating machine 1 according to the seventh embodiment; therefore, only the differences therebetween will be described hereinafter.

As described previously, in the seventh embodiment, for each of the stator teeth 9, the magnetic shields are implemented by the short-circuited coils 20-22 that are respectively provided within the grooves formed between the stator toothlets 12 of the stator tooth 9 and on the forward end surface 24 of the one of the stator toothlets 12 which is located most forward.

In comparison, in the present embodiment, as shown in FIG. 17, for each of the stator teeth 9, the magnetic shields are implemented by short-circuited coils 30 each of which is provided on the forward end surface 24 of a corresponding one of the stator toothlets 12 of the stator tooth 9.

More specifically, in the present embodiment, for each of the stator toothlets 12, there are formed, at the forward end surface 24 of the stator toothlet 12, a protrusion 31 and a groove 32 that surrounds the protrusion 31.

Each of the short-circuited coils 30 is wound around the protrusion 31 of the corresponding stator toothlet 12 so as to be received in the groove 32 of the corresponding stator toothlet 12.

With the above arrangement of the short-circuited coils 30 according to the present embodiment, it is possible to achieve the same advantageous effects as with the arrangement of the short-circuited coils 20-22 according to the seventh embodiment.

### Eleventh Embodiment

This embodiment illustrates an electric rotating machine 1 which has almost the same configuration as the electric rotating machine 1 according to the eighth embodiment; therefore, only the differences therebetween will be described hereinafter.

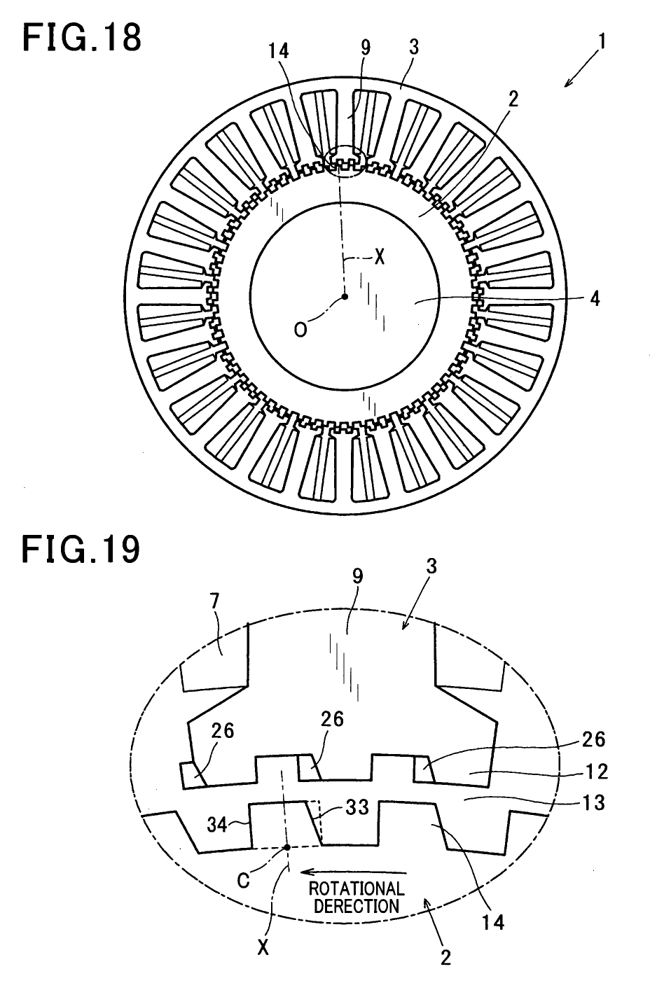

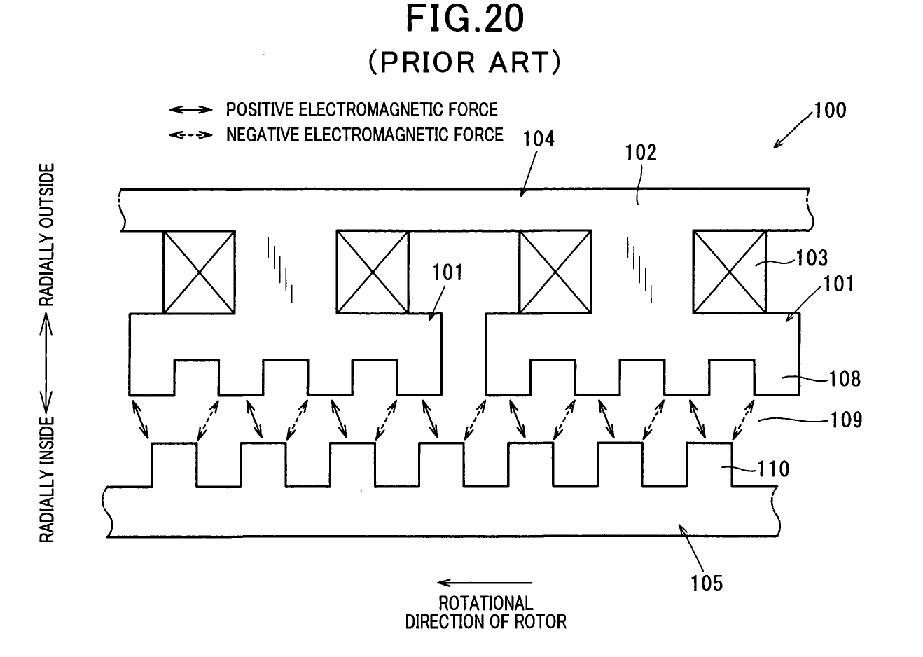

Referring to FIGS. 18 and 19, in the present embodiment, each of the rotor toothlets 14 is shaped so as to be asymmetric with respect to an imaginary line X. The imaginary line X is defined to extend straight through both the circumferential center C of the rotor toothlet 14 at the proximal end of the rotor toothlet 14 and the radial center O of the rotating shaft 4 of the rotor 2.

More specifically, in the present embodiment, each of the rotor toothlets 14 has such a trapezoidal shape that the backward end surface 33 of the rotor toothlet 14 is oblique to the imaginary line X while the forward end surface 34 is parallel to the imaginary line X. Consequently, the air gap 13 between the rotor tooth let 14 and the stator toothlets 12 is widened on the backward side (or on the upstream side with respect to the rotational direction of the rotor 2) of the rotor toothlet 14 by the triangular area indicated with a dallied line in FIG. 19. As a result, the air gap 13 also becomes asymmetric with respect to the imaginary line X.

With the above configuration, it is possible to lower, for each of the rotor toothlets 14, the magnetic permeability between the rotor toothlet 14 and the stator toothlets 12 on the backward side of the rotor toothlet 14, thereby further reducing the negative magnetic force generated between the rotor toothlet 14 and the stator toothlets 12.

In addition, in the present embodiment, each of the magnetic shields 26 is modified to have a trapezoidal cross-sectional shape as shown in FIG. 19.

While the above particular embodiments have been shown and described, it will be understood by those skilled in the art that various modifications, changes, and improvements may be made without departing from the spirit of the invention.

For example, in the first to the third and the fifth embodiments, the magnetic shields are provided only at the magnetic salient poles 5 of the rotor core 2a. However, it is also possible to provide magnetic shields both at the magnetic salient poles 5 and at the distal end portions 9a of the stator teeth 9.

Moreover, in the seventh to the eleventh embodiments, the electric rotating machine 1 is configured as a reluctance stepping motor. However, the present invention can also be applied to other electric rotating machines which have stator toothlets and rotor toothlets, such as a switched reluctance motor and a vernier motor. In addition, the technique of providing the magnetic shields at the stator toothlets 12 can also be applied to linear motors.

In the seventh embodiment, the stator coil 7 is wound on the stator core 6 using a concentrated winding method. However, the stator coil 7 may also be wound on the stator core 6 using a distributed winding method_{—}

In the seventh to the eleventh embodiments, the magnetic shields are provided only at the stator toothlets 12. However, it is also possible to provide magnetic shields only at the rotor toothlets 14 or both at the stator toothlets 12 and at the rotor toothlets 14.

In the eighth and ninth embodiments, each of the electric conductor plates 26 and 28 has a rectangular cross-sectional shape. On the other hand, in the eleventh embodiment, each of the electric conductor plates 26 has a trapezoidal cross-sectional shape. It should be noted that each of the electric conductor plates 26 and 28 may also have other cross-sectional shapes according to the design specification.

In the ninth embodiment, the radial width of the electric conductor plates 26 is set to be higher than that of the electric conductor plates 28. However, it is also possible to set the radial width of the electric conductor plates 26 equal to that of the electric conductor plates 28 and the material of the electric conductor plates 26 different from that of the electric conductor plates 28. That is, to the extend that the magnetic flux can be asymmetrically generated at the forward end surfaces 24 and at the backward end surfaces 27 of the stator toothlets 12, it is possible to set the radial widths of the electric conductor plates 26 and 28 to other suitable values.

What is claimed is:

1. An electric rotating machine comprising:
a stator including a stator core and a stator coil wound on the stator core, the stator core having a plurality of stator teeth arranged in a circumferential direction of the stator core;
a rotor including a rotor core that has a plurality of magnetic salient poles formed therein, the magnetic salient poles facing the stator teeth through an air gap formed therebetween; and
a plurality of magnetic shields each of which is provided, either on a forward side of a corresponding one of the stator teeth or on a backward side of a corresponding one of the magnetic salient poles with respect to a rotational direction of the rotor, to create a magnetic flux which suppresses generation of an electromagnetic force that hinders rotation of the rotor.

2. The electric rotating machine as set forth in claim 1, wherein each of the magnetic shields is made of an electric conductor.

3. The electric rotating machine as set forth in claim 2, wherein the magnetic shields are electrically insulated from the stator core and the rotor core.

4. The electric rotating machine as set forth in claim 2, wherein each of the magnetic shields is made of copper or aluminum.

5. The electric rotating machine as set forth in claim 2, wherein each of the magnetic shields is made up of an electric conductor plate.

6. The electric rotating machine as set forth in claim 2, wherein each of the magnetic shields is made up of a short-circuited coil.

7. The electric rotating machine as set forth in claim 1, wherein each of the magnetic salient poles of the rotor core is made up of a protrusion that protrudes toward the stator.

8. The electric rotating machine as set forth in claim 1, wherein the rotor core is comprised of a plurality of substantially U-shaped rotor core segments that are arranged in a circumferential direction of the rotor core at predetermined intervals,
each of the rotor core segments has a pair of protruding portions, which are respectively formed at opposite circumferential ends of the rotor core segment so as to protrude toward the stator, and a connecting portion that extends in the circumferential direction of the rotor core to connect the protruding portions, and
each of the magnetic salient poles of the rotor core is made up of a corresponding circumferentially-adjacent pair of the protruding portions of different ones of the rotor core segments.

9. The electric rotating machine as set forth in claim 1, wherein the rotor core has a plurality of high magnetic reluctance portions and a plurality of low magnetic reluctance portions,
the high magnetic reluctance portions are spaced from one another in a circumferential direction of the rotor core,
each of the low magnetic reluctance portions has a lower magnetic reluctance than the high magnetic reluctance portions and is formed between a corresponding circumferentially-adjacent pair of the high magnetic reluctance portions, and
each of the magnetic salient poles of the rotor core is made up of a corresponding one of the low magnetic reluctance portions.

10. The electric rotating machine as set forth in claim 1, wherein each of the stator teeth has a plurality of stator toothlets formed at a distal end thereof,
the rotor core has a plurality of rotor toothlets each of which makes up one of the magnetic salient poles, and
each of the magnetic shields is provided either on a forward side of a corresponding one of the stator toothlets or on a backward side of a corresponding one of the rotor toothlets with respect to the rotational direction of the rotor.

11. An electric rotating machine comprising:
a stator including a stator core and a stator coil wound on the stator core, the stator core having a plurality of stator teeth arranged in a circumferential direction of the stator core, each of the stator teeth having a plurality of stator toothlets formed at a distal end thereof; and
a rotor including a rotor core that has a plurality of rotor toothlets formed therein, the rotor toothlets facing the stator toothlets through an air gap formed therebetween,
wherein
for each of the stator teeth, there are provided, at the stator toothlets of the stator tooth, a plurality of magnetic shields to create a magnetic flux which suppresses generation of an electromagnetic force that hinders rotation of the rotor.

12. The electric rotating machine as set forth in claim 11, wherein each of the magnetic shields is made of an electric conductor.

13. The electric rotating machine as set forth in claim 12, wherein the magnetic shields are electrically insulated from the stator toothlets.

14. The electric rotating machine as set forth in claim 12, wherein each of the magnetic shields is made of copper or aluminum.

15. The electric rotating machine as set forth in claim 12, wherein each of the magnetic shields is made up of an electric conductor plate.

16. The electric rotating machine as set forth in claim 12, wherein each of the magnetic shields is made up of, a short-circuited coil.

17. The electric rotating machine as set forth in claim 11, wherein each of the rotor toothlets is shaped so as to be asymmetric with respect to an imaginary line, the imaginary line being defined to extend straight through both a circumferential center of the rotor toothlet at a proximal end of the rotor toothlet and a radial center of a rotating shaft of the rotor, and
for each of the rotor toothlets, the air gap is wider on a backward side than on a forward side of the rotor toothlet with respect to a rotational direction of the rotor.
